(19) United States
(12) Patent Application Publication
(10) Pub. No.: US 2025/0342997 A1
(43) Pub. Date: Nov. 6, 2025

(54) COIL COMPONENT

(71) Applicant: Murata Manufacturing Co., Ltd., Kyoto-fu (JP)

(72) Inventors: Kouhei MATSUURA, Nagaokakyo-shi (JP); Kouta ONO, Nagaokakyo-shi (JP)

(73) Assignee: Murata Manufacturing Co., Ltd., Kyoto-fu (JP)

(21) Appl. No.: 19/265,887

(22) Filed: Jul. 10, 2025

Related U.S. Application Data
(63) Continuation of application No. PCT/JP2024/020683, filed on Jun. 6, 2024.

(30) Foreign Application Priority Data
Aug. 17, 2023 (JP) 2023-133020

(51) Int. Cl. H01F 27/245; H01F 1/34; H01F 27/28

(52) U.S. Cl. CPC H01F 27/245; H01F 1/34; H01F 2027/2809

(57) ABSTRACT

A coil component includes a base body including a multilayer body in which a first ferrite layer, a second ferrite layer, a glass layer, a third ferrite layer, and a fourth ferrite layer are stacked in this order; a coil inside the glass layer; and an outer electrode on an outer surface of the base body and electrically connected to the coil. A ferrite material that constitutes the first, second, third and fourth ferrite layers contains X (X≥0) mol % of Zn in terms of ZnO and Y (Y≥0) mol % of Ni in terms of NiO, and X+Y>0, when the amounts of Fe, Zn, Cu, and Ni are respectively expressed in terms of Fe₂O₃, ZnO, CuO, and NiO, and the total amount of Fe₂O₃, ZnO, CuO, and NiO is 100 mol %.

### CROSS-REFERENCE TO RELATED APPLICATIONS

This application claims benefit of priority to International Patent Application No. PCT/JP2024/020683, filed Jun. 6, 2024, and to Japanese Patent Application No. 2023-133020, filed Aug. 17, 2023, the entire contents of each are incorporated herein by reference.

### BACKGROUND

### Technical Field

The present disclosure relates to a coil component.

### Background Art

Japanese Patent No. 6569078 discloses a common mode noise filter including: a first non-magnetic portion; a first magnetic portion formed on a lower surface of the first non-magnetic portion; a second magnetic portion formed on an upper surface of the first non-magnetic portion; a first coil and a second coil buried in the first non-magnetic portion and composed of Ag; and a second non-magnetic portion formed on at least one of the lower surface of the first magnetic portion and the upper surface of the second magnetic portion and located on the outermost side, wherein the first non-magnetic portion and the second non-magnetic portion are composed of a filler and glass, and the second non-magnetic portion has a lower filler content than the first non-magnetic portion.

### SUMMARY

In the common mode noise filter described in Japanese Patent No. 6569078, the second non-magnetic portion, which is the outermost layer, is a dielectric glass layer and has low strength, and the base body may crack due to stress caused by substrate deflection. During sintering of the unsintered base body, the Si component contained in the first non-magnetic portion at the center may erode the first magnetic portion and the second magnetic portion and may degrade the sinterability of the base body.

Accordingly, the present disclosure provides a coil component having high base body strength while maintaining sinterability.

A coil component of the present disclosure includes a base body including a multilayer body in which a first ferrite layer, a second ferrite layer, a glass layer, a third ferrite layer, and a fourth ferrite layer are stacked in this order; a coil disposed inside the glass layer; and an outer electrode disposed on an outer surface of the element body and electrically connected to the coil, wherein a ferrite material that constitutes the first ferrite layer, the second ferrite layer, the third ferrite layer, and the fourth ferrite layer contains X (X≥0) mol % of Zn in terms of ZnO and Y (Y≥0) mol % of Ni in terms of NiO, and X+Y>0, when amounts of Fe, Zn, Cu, and Ni are respectively expressed in terms of Fe₂O₃, ZnO, CuO, and NiO, and a total amount of Fe₂O₃, ZnO, CuO, and NiO is 100 mol %, a ferrite material that constitutes the second ferrite layer and the third ferrite layer has an X/(X+Y) of 0 or more and 0.73 or less (i.e., from 0 to 0.73), and a ferrite material that constitutes the first ferrite layer and the fourth ferrite layer has an X/(X+Y) of more than 0.73 and 1.0 or less (i.e., from more than 0.73 to 1.0).

The present disclosure can provide a coil component having high base body strength while maintaining sinterability.

### BRIEF DESCRIPTION OF THE DRAWINGS

FIG. 1 is a schematic perspective view illustrating an example of a coil component of the present disclosure;

FIG. 2 is a schematic cross-sectional view illustrating an example of the cross section of the coil component in FIG. 1 taken along line A1-A1;

FIG. 3 is an exploded perspective view illustrating an example of the exploded state of the coil component (other than outer electrodes) in FIG. 1; and

FIG. 4 is a graph illustrating the cutoff frequencies of the samples in Examples and Comparative Examples, as obtained from simulation.

### DETAILED DESCRIPTION

A coil component of the present disclosure will be described below. The present disclosure is not limited to the following configurations and may be appropriately modified without departing from the spirit of the present disclosure. A combination of two or more individual preferred configurations described below is also within the present disclosure.

Hereinafter, a common mode choke coil is described as an example of the coil component of the present disclosure. The coil component of the present disclosure can also be applied to coil components other than common mode choke coils.

The figures described below illustrate schematic views, and the dimensions, the aspect ratio, and the like are not necessarily drawn to scale. In the figures, the same or corresponding parts are denoted by the same reference signs. In the figures, the same elements are denoted by the same reference signs, and redundant descriptions are omitted.

In the following description, the terms (e.g., “parallel” and “perpendicular”) expressing the relationship between elements and the terms expressing the shapes of elements do not refer only to strictly literal forms but also encompass substantially equivalent ranges, such as ranges including differences of several percent.

In the coil component of the present disclosure, a base body includes a multilayer body in which a first ferrite layer, a second ferrite layer, a glass layer, a third ferrite layer, and a fourth ferrite layer are stacked in this order.

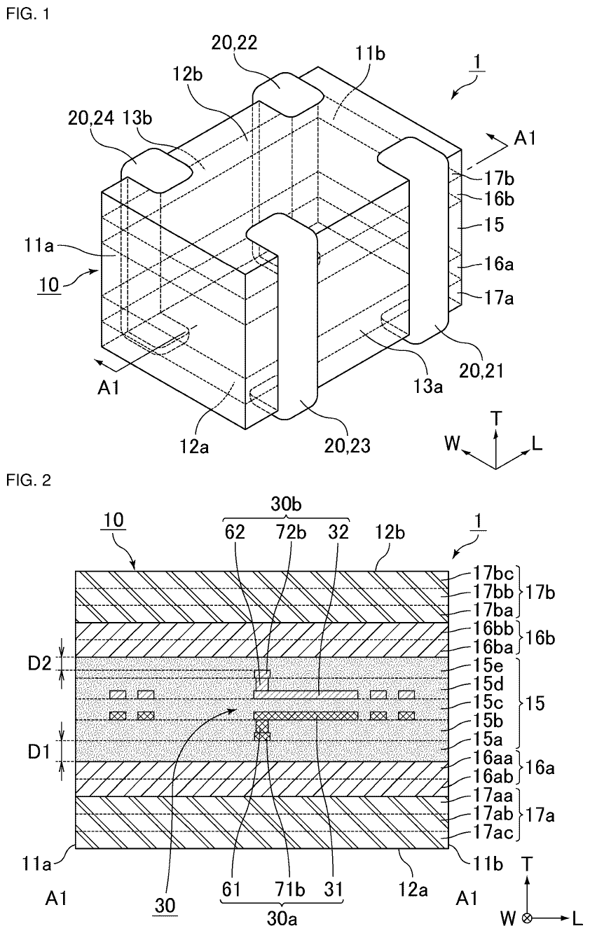

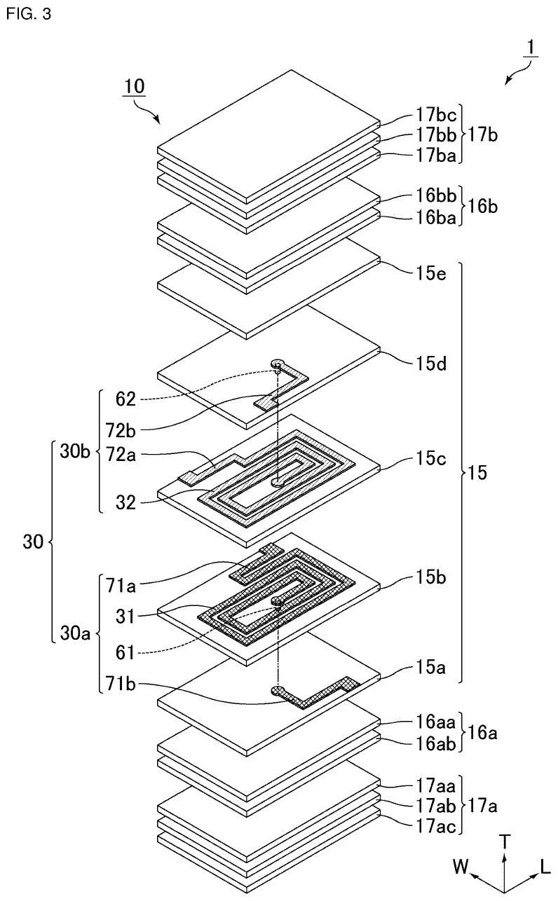

FIG. 1 is a schematic perspective view illustrating an example of the coil component of the present disclosure. FIG. 2 is a schematic cross-sectional view illustrating an example of the cross section of the coil component in FIG. 1 taken along line A1-A1. FIG. 3 is an exploded perspective view illustrating an example of the exploded state of the coil component (other than outer electrodes) in FIG. 1.

A coil component 1 illustrated in FIG. 1 is what is called a common mode choke coil. The coil component 1 includes: a base body 10; a coil 30 (see FIG. 2 and FIG. 3) disposed inside the base body 10; and outer electrodes 20 disposed on the outer surfaces of the base body 10 and electrically connected to the coil 30.

In this description, the length direction, the height direction, and the width direction are respectively defined by L, T and W, as illustrated in FIG. 1 and other figures. The length direction L, the height direction T, and the width direction W are perpendicular to each other.

The base body 10 has, for example, a rectangular parallelepiped shape or a substantially rectangular parallelepiped shape. The base body 10 has a first end surface 11a and a second end surface 11b facing each other in the length direction L, a first main surface 12a and a second main surface 12b facing each other in the height direction T, and a first side surface 13a and a second side surface 13b facing each other in the width direction W.

When the coil component 1 is mounted on a substrate, the first main surface 12a of the base body 10 serves as a mounting surface.

The base body 10 may have rounded corners and rounded edges. The corners of the base body 10 are places where three faces of the base body 10 meet. The edges of the base body 10 are places where two faces of the base body 10 meet.

The base body 10 contains a multilayer body in which a first ferrite layer 17a, a second ferrite layer 16a, a glass layer 15, a third ferrite layer 16b, and a fourth ferrite layer 17b are stacked in this order. In the example illustrated in FIGS. 1, 2, and 3, the first ferrite layer 17a, the second ferrite layer 16a, the glass layer 15, the third ferrite layer 16b, and the fourth ferrite layer 17b are stacked in the height direction T.

In other words, the base body 10 includes: the glass layer 15; the second ferrite layer 16a and the third ferrite layer 16b, which sandwich the glass layer 15 in the stacking direction (the height direction T in this case); the first ferrite layer 17a and the fourth ferrite layer 17b, which sandwich the second ferrite layer 16a and the third ferrite layer 16b in the stacking direction (the height direction T in this case). In other words, in the stacking direction (the height direction T in this case), the second ferrite layer 16a is disposed on one main surface of the glass layer 15, and the third ferrite layer 16b is disposed on the other main surface of the glass layer 15. In the stacking direction (the height direction T in this case), the first ferrite layer 17a is disposed on one main surface (the main surface facing away from the glass layer 15) of the second ferrite layer 16a, and the fourth ferrite layer 17b is disposed on the other main surface (the main surface facing away from the glass layer 15) of the third ferrite layer 16b.

Since the outermost layers, the first ferrite layer 17a and the fourth ferrite layer 17b, are ferrite layers and not glass layers, the base body 10 is highly resistant to stress caused by substrate deflection.

The ferrite material that constitutes the first ferrite layer 17a, the second ferrite layer 16a, the third ferrite layer 16b, and the fourth ferrite layer 17b contains X (X≥0, i.e., X is a real number of 0 or more and less than 100 (i.e., from 0 to less than 100)) mol % of Zn in terms of ZnO and Y (Y≥0, i.e., Y is a real number of 0 or more and less than 100 (i.e., from 0 to less than 100)) mol % of Ni in terms of NiO, and X+Y>0, when the amounts of Fe, Zn, Cu, and Ni are respectively expressed in terms of Fe₂O₃, ZnO, CuO, and NiO, and the total amount of Fe₂O₃, ZnO, CuO, and NiO is 100 mol %. The ferrite material that constitutes the second ferrite layer 16a and the third ferrite layer 16b has an X/(X+Y) of 0 or more and 0.73 or less (i.e., from 0 to 0.73). The ferrite material that constitutes the first ferrite layer 17a and the fourth ferrite layer 17b has an X/(X+Y) of more than 0.73 and 1.0 or less (i.e., from more than 0.73 to 1.0).

When the amounts of Fe, Zn, Cu, and Ni are respectively expressed in terms of Fe₂O₃, ZnO, CuO, and NiO, and the total amount of Fe₂O₃, ZnO, CuO, and NiO is 100 mol %, and when the amount of Zn and the amount of Ni in the ferrite material that constitutes one ferrite layer are respectively X mol % in terms of ZnO and Y mol % in terms of NiO (X and Y are real numbers of 0 or more and less than 100 (i.e., from 0 to less than 100)), the ratio calculated from the formula X/(X+Y) is expressed as Zn/(Zn+Ni) of the ferrite layer (ferrite material).

During sintering of the unsintered base body 10, the Si component contained in the glass layer 15 may erode the second ferrite layer 16a and the third ferrite layer 16b. In general, as the proportion of the Zn component in the ferrite layer increases, the Si component in the glass layer erodes the ferrite layer more deeply. This may be because the Si component in the glass layer easily replaces the Zn component in the ferrite layer.

With regard to the coil component 1, the erosion of the second ferrite layer 16a and the third ferrite layer 16b caused by the Si component in the glass layer 15 can be prevented or reduced by reducing the ZnO content of the second ferrite layer 16a and the third ferrite layer 16b, specifically by reducing the Zn/(Zn+Ni) value of the second ferrite layer 16a and the third ferrite layer 16b to 0.73 or less. In other words, it is possible to prevent or reduce the degradation of sinterability caused by the chemical reactions between the second ferrite layer 16a and the glass layer 15 and between the third ferrite layer 16b and the glass layer 15.

If the Zn/(Zn+Ni) of the second ferrite layer 16a and the third ferrite layer 16b exceeds 0.73, the second ferrite layer 16a and the third ferrite layer 16b may exhibit poor compatibility with glass. As a result, the erosion of the second ferrite layer 16a and the third ferrite layer 16b caused by the Si component in the glass layer 15 is more likely to progress.

The Zn/(Zn+Ni) of the first ferrite layer 17a and the fourth ferrite layer 17b exceeds 0.73, but the second ferrite layer 16a and the third ferrite layer 16b are respectively interposed between the first ferrite layer 17a and the glass layer 15 and between the fourth ferrite layer 17b and the glass layer 15. Therefore, there are no particular issues regarding the sinterability of the first ferrite layer 17a and the fourth ferrite layer 17b.

In the coil component 1, the strength of the base body 10 can be improved while maintaining sinterability.

The high-frequency characteristics of the coil component 1 can be improved by disposing the first ferrite layer 17a and the fourth ferrite layer 17b in addition to the second ferrite layer 16a and the third ferrite layer 16b, compared to the case without the first ferrite layer 17a and the fourth ferrite layer 17b.

The Zn/(Zn+Ni) of the second ferrite layer 16a and the third ferrite layer 16b is preferably 0.02 or more and 0.73 or less (i.e., from 0.02 to 0.73), more preferably 0.36 or more and 0.72 or less (i.e., from 0.36 to 0.72).

The Zn/(Zn+Ni) of the second ferrite layer 16a and the Zn/(Zn+Ni) of the third ferrite layer 16b are preferably the same as each other, but they may differ from each other.

The Zn/(Zn+Ni) of the first ferrite layer 17a and the fourth ferrite layer 17b is not limited as long as it is more than 0.73 and 1.0 or less (i.e., from more than 0.73 to 1.0), preferably 0.95 or more and 1.0 or less (i.e., from 0.95 to 1.0).

The Zn/(Zn+Ni) of the first ferrite layer 17a and the Zn/(Zn+Ni) of the fourth ferrite layer 17b are preferably the same as each other, but they may differ from each other.

Referring to FIG. 2, the glass layer 15 has, for example, a multilayer structure in which a plurality of insulating layers are stacked in the stacking direction (the height direction T in this case).

The glass layer 15 includes an insulating layer 15a, an insulating layer 15b, an insulating layer 15c, an insulating layer 15d, and an insulating layer 15e stacked in sequence in the stacking direction (the height direction T in this case). More specifically, in the glass layer 15, the insulating layer 15a, the insulating layer 15b, the insulating layer 15c, the insulating layer 15d, and the insulating layer 15e are stacked in sequence from the first main surface 12a side to the second main surface 12b side of the base body 10.

The insulating layer 15a, the insulating layer 15b, the insulating layer 15c, the insulating layer 15d, and the insulating layer 15e are preferably made of the same constituent material, but may be made of different constituent materials, or one or some of the insulating layers may be made of a different constituent material.

For convenience of description, the boundaries between the insulating layers that constitute the glass layer 15 are illustrated in FIG. 2; however, these boundaries are not clearly visible in practice.

The glass layer 15 is preferably composed of a glass ceramic material containing a glass material and a filler. In that case, the glass material contained in the glass layer 15 preferably contains at least an alkali metal (preferably K), B, and Si. The filler contained in the glass layer 15 preferably contains at least one selected from the group consisting of quartz (SiO₂), alumina (Al₂O₃), and forsterite (2MgO·SiO₂). In particular, the filler contained in the glass layer 15 preferably contains quartz, alumina, and forsterite.

When the glass ceramic material contains a glass material and contains quartz, alumina, and forsterite as fillers, the glass ceramic material preferably contains 70 wt % or more and 80 wt % or less (i.e., from 70 wt % to 80 wt %) of a glass material containing at least an alkali metal (preferably K), B, and Si, 2 wt % or more and 4 wt % or less (i.e., from 2 wt % to 4 wt %) of alumina, 12 wt % or more and 14 wt % or less (i.e., from 12 wt % to 14 wt %) of quartz, and 5 wt % or more and 15 wt % or less (i.e., from 5 wt % to 15 wt %) of forsterite.

The glass ceramic material contains, relative to 100 wt % of the total weight, 9 wt % or more and 13 wt % or less (i.e., from 9 wt % to 13 wt %) of B in terms of B₂O₃, 2 wt % or more and 4 wt % or less (i.e., from 2 wt % to 4 wt %) of Al in terms of Al₂O₃; 75 wt % or more and 85 wt % or less (i.e., from 75 wt % to 85 wt %) of Si in terms of SiO₂; 0.5 wt % or more and 2 wt % or less (i.e., from 0.5 wt % to 2 wt %) of K in terms of K₂O; and 3 wt % or more and 10 wt % or less (i.e., from 3 wt % to 10 wt %) of Mg in terms of MgO.

The thickness (the dimension in the height direction T) of the glass layer 15 is, for example, 20 μm or more and 300 μm or less (i.e., from 20 μm to 300 μm), preferably 30 μm or more and 200 μm or less (i.e., from 30 μm to 200 μm). If the thickness of the glass layer 15 is not uniform, the thickness of the glass layer 15 is measured at 15 random locations, and the average value of the measurements is taken as the “thickness of the glass layer 15” in the present disclosure.

Referring to FIG. 2, the second ferrite layer 16a and the third ferrite layer 16b each have, for example, a multilayer structure in which a plurality of insulating layers are stacked in the stacking direction (the height direction T in this case), as described below.

The second ferrite layer 16a includes an insulating layer 16aa and an insulating layer 16ab stacked in the stacking direction (the height direction T in this case). More specifically, the insulating layer 16aa and the insulating layer 16ab are stacked in sequence from the glass layer 15 side in the second ferrite layer 16a.

For convenience of description, the boundaries between the insulating layers that constitute the second ferrite layer 16a are illustrated in FIG. 2; however, these boundaries are not clearly visible in practice.

The third ferrite layer 16b includes an insulating layer 16ba and an insulating layer 16bb stacked in the stacking direction (the height direction T in this case). More specifically, the insulating layer 16ba and the insulating layer 16bb are stacked in sequence from the glass layer 15 side in the third ferrite layer 16b.

For convenience of description, the boundaries between the insulating layers that constitute the third ferrite layer 16b are illustrated in FIG. 2; however, these boundaries are not clearly visible in practice.

The ferrite material that constitutes the second ferrite layer 16a may be the same as or different from the ferrite material that constitutes the third ferrite layer 16b. The second ferrite layer 16a and the third ferrite layer 16b are preferably composed of the same ferrite material.

The ferrite material (hereinafter referred to as low-Zn ferrite material) that constitutes the second ferrite layer 16a and the third ferrite layer 16b contains, for example, Fe, Zn, Cu, and Ni as main components. The low-Zn ferrite material may further contain sub-components, such as Mn, Co, Sn, Bi, and Si, in addition to the above main components. The low-Zn ferrite material may further contain incidental impurities.

The low-Zn ferrite material preferably contains 40 mol % or more and 56 mol % or less (i.e., from 40 mol % to 56 mol %) of Fe in terms of Fe₂O₃, 1 mol % or more and 35 mol % or less (i.e., from 1 mol % to 35 mol %) of Zn in terms of ZnO, 6 mol % or more and 14 mol % or less (i.e. from 6 mol % to 14 mol %) of Cu in terms of CuO, and 8 mol % or more and 40 mol % or less (i.e., from 8 mol % to 40 mol %) of Ni in terms of NiO.

The low-Zn ferrite material may be a magnetic ferrite material. The magnetic ferrite material may have a magnetic permeability of 30 or more at 1 MHz.

The second ferrite layer 16a and the third ferrite layer 16b each preferably have a thickness (the dimension in the height direction T) of 3.3 μm or more, more preferably a thickness of 5.0 μm or more. When the second ferrite layer 16a and the third ferrite layer 16b have a thickness of 3.3 μm or more, it is possible to prevent or reduce the erosion of the second ferrite layer 16a and the third ferrite layer 16b caused by the Si component in the glass layer 15 so that the Si component is unlikely to reach the first ferrite layer 17a and the fourth ferrite layer 17b.

The second ferrite layer 16a and the third ferrite layer 16b each preferably have a thickness of 110 μm or less, more preferably a thickness of 30 μm or less. The high-frequency characteristics of the coil component 1 are improved by setting the thickness of the second ferrite layer 16a and the third ferrite layer 16b to 110 μm or less. More specifically, a cutoff frequency (the frequency at which the signal transmission characteristic Sdd21 is −3 dB) of 6 GHz or higher can be achieved.

The thickness of the second ferrite layer 16a may be the same as or different from that of the third ferrite layer 16b. If the thickness of the second ferrite layer 16a is not uniform, the thickness of the second ferrite layer 16a is measured at 15 random locations, and the average value of the measurements is taken as the “thickness of the second ferrite layer 16a” in the present disclosure. Similarly, if the thickness of the third ferrite layer 16b is not uniform, the thickness of the third ferrite layer 16b is measured at 15 random locations, and the average value of the measurements is taken as the “thickness of the third ferrite layer 16b.”

The first ferrite layer 17a and the fourth ferrite layer 17b each have, for example, a multilayer structure in which a plurality of insulating layers are stacked in the stacking direction (the height direction T in this case), as described below.

The first ferrite layer 17a includes an insulating layer 17aa, an insulating layer 17ab, and an insulating layer 17ac stacked in the stacking direction (the height direction T in this case). More specifically, the insulating layer 17aa, the insulating layer 17ab, and the insulating layer 17ac are stacked in sequence from the glass layer 15 side in the first ferrite layer 17a.

For convenience of description, the boundaries between the insulating layers that constitute the first ferrite layer 17a are illustrated in FIG. 2; however, these boundaries are not clearly visible in practice.

The fourth ferrite layer 17b includes an insulating layer 17ba, an insulating layer 17bb, and an insulating layer 17bc stacked in the stacking direction (the height direction T in this case). More specifically, the insulating layer 17ba, the insulating layer 17bb, and the insulating layer 17bc are stacked in sequence from the glass layer 15 side in the fourth ferrite layer 17b.

For convenience of description, the boundaries between the insulating layers that constitute the fourth ferrite layer 17b are illustrated in FIG. 2; however, these boundaries are not clearly visible in practice.

The ferrite material that constitutes the first ferrite layer 17a may be the same as or different from the ferrite material that constitutes the fourth ferrite layer 17b. The first ferrite layer 17a and the fourth ferrite layer 17b are preferably composed of the same ferrite material.

The ferrite material (hereinafter referred to as Zn-rich ferrite material) that constitutes the first ferrite layer 17a and the fourth ferrite layer 17b contains, for example, Fe, Zn, Cu, and Ni as main components. However, Ni may be absent. The Zn-rich ferrite material may further contain sub-components, such as Mn, Co, Sn, B, and Si, in addition to the above main components. The Zn-rich ferrite material may further contain incidental impurities.

The Zn-rich ferrite material preferably contains 40 mol % or more and 56 mol % or less (i.e., from 40 mol % to 56 mol %) of Fe in terms of Fe₂O₃, 36 mol % or more and 55 mol % or less (i.e., from 36 mol % to 55 mol %) of Zn in terms of ZnO, 6 mol % or more and 14 mol % or less (i.e., from 6 mol % to 14 mol %) of Cu in terms of CuO, and 0 mol % or more and 8 mol % or less (i.e., from 0 mol % to 8 mol %) of Ni in terms of NiO.

The Zn-rich ferrite material may be a non-magnetic ferrite material. The non-magnetic ferrite material may have a magnetic permeability of 3 or less at 1 MHz.

The first ferrite layer 17a and the fourth ferrite layer 17b each have a thickness (the dimension in the height direction T) of, for example, 80 μm or more and 190 μm or less (i.e., from 80 μm to 190 μm), preferably 160 μm or more and 185 μm or less (i.e., from 160 μm to 185 μm).

The thickness of the first ferrite layer 17a may be the same as or different from that of the fourth ferrite layer 17b. If the thickness of the first ferrite layer 17a is not uniform, the thickness of the first ferrite layer 17a is measured at 15 random locations, and the average value of the measurements is taken as the “thickness of the first ferrite layer 17a” in the present disclosure. Similarly, if the thickness of the fourth ferrite layer 17b is not uniform, the thickness of the fourth ferrite layer 17b is measured at 15 random locations, and the average value of the measurements is taken as the “thickness of the fourth ferrite layer 17b.”

The glass layer is distinguished from the ferrite layers as described below. First, the periphery of the coil component is sealed with resin as necessary, and the coil component is then polished in a first direction (e.g., length direction) perpendicular to the stacking direction (e.g., height direction) to expose the cross section taken at substantially the center in the first direction and along the stacking direction and the second direction (e.g., width direction) perpendicular to the stacking direction and the first direction. Next, a region in the exposed cross section of the base body where different layers can be presumed to be present (e.g., a region where different layers can be presumed to be present on the basis of differences in color tone and the like) is subjected to scanning transmission electron microscope-energy dispersive X-ray spectroscopy (STEM-EDX) to determine the composition (content ratio of elements of interest). The glass layer is distinguished from the ferrite layers by determining whether the constituent material of each layer is a glass ceramic material or a ferrite material on the basis of the obtained composition. In addition, each ferrite layer is distinguished on the basis of the obtained composition.

The coil 30 includes, for example, two coils, specifically a primary coil 30a and a secondary coil 30b. The number of coils 30 is not limited to two, but may be only one, or three or more.

Referring to FIG. 2, the primary coil 30a and the secondary coil 30b are disposed inside the glass layer 15. The primary coil 30a and the secondary coil 30b are insulated from each other.

The primary coil 30a and the secondary coil 30b are disposed in sequence in the stacking direction (the height direction T in this case) of the base body 10 to form a common mode choke coil.

The coil 30 including the primary coil 30a and the secondary coil 30b is composed of, for example, a conductive material, such as Ag or Cu. The conductive material that constitutes the coil 30 is preferably Ag. Thus, the coil 30 preferably contains at least Ag.

Referring to FIG. 3, the primary coil 30a and the secondary coil 30b have a spiral pattern wound spirally in the same direction as observed in the stacking direction (the height direction T in this case). The coil 30 including the primary coil 30a and the secondary coil 30b is electrically connected to any one of the outer electrodes 20.

Specifically, the primary coil 30a has a coil conductor 31 wound spirally, an extended conductor 71a connected to one end of the coil conductor 31 on the outer peripheral side of the spiral, a via conductor 61 connected to the other end of the coil conductor 31 on the central side, and an extended conductor 71b connected to the via conductor 61. One end of the coil conductor 31 on the outer peripheral side of the spiral is connected to one end of the extended conductor 71a, and the other end of the extended conductor 71a is extended to the outer surface of the base body 10. The other end of the coil conductor 31 on the central side of the spiral is connected to one end of the extended conductor 71b with the via conductor 61 inside the glass layer 15 interposed therebetween, and the other end of the extended conductor 71b is extended to the outer surface of the base body 10.

Similarly, the secondary coil 30b has a coil conductor 32 wound spirally, an extended conductor 72a connected to one end of the coil conductor 32 on the outer peripheral side of the spiral, a via conductor 62 connected to the other end of the coil conductor 32 on the central side, and an extended conductor 72b connected to the via conductor 62. One end of the coil conductor 32 on the outer peripheral side of the spiral is connected to one end of the extended conductor 72a, and the other end of the extended conductor 72a is extended to the outer surface of the base body 10. The other end of the coil conductor 32 on the central side of the spiral is connected to one end of the extended conductor 72b with the via conductor 62 inside the glass layer 15 interposed therebetween, and the other end of the extended conductor 72b is extended to the outer surface of the base body 10.

The greater the distance from the primary coil 30a to the second ferrite layer 16a, the better the high-frequency characteristics of the coil component 1. Specifically, as illustrated in FIG. 2, the distance D1 between the primary coil 30a (extended conductor 71b) and the second ferrite layer 16a in the stacking direction (the height direction T in this case) is preferably 5 μm or more, more preferably 10 μm or more. The upper limit of the distance D1 can be set as desired, but it is preferably 40 μm or less, more preferably 25 μm or less.

Similarly, the greater the distance from the secondary coil 30b to the third ferrite layer 16b, the better the high-frequency characteristics of the coil component 1. Specifically, as illustrated in FIG. 2, the distance D2 between the secondary coil 30b (extended conductor 72b) and the third ferrite layer 16b in the stacking direction (the height direction T in this case) is preferably 5 μm or more, more preferably 10 μm or more. The upper limit of the distance D2 can be set as desired, but it is preferably 40 μm or less, more preferably 25 μm or less.

The outer electrodes 20 include, for example, a first outer electrode 21, a second outer electrode 22, a third outer electrode 23, and a fourth outer electrode 24. The number of outer electrodes 20 is not limited to four (i.e., two pairs), but it varies according to the number of coils 30. Thus, the number of outer electrodes 20 may be two (i.e., one pair), three or more, or for example, six (i.e., three pairs).

The outer electrodes 20 are electrically connected to the coil 30. In FIGS. 2 and 3, one end of the primary coil 30a is extended to the outer surface of the base body 10 and connected to the first outer electrode 21, and the other end is extended to the outer surface of the base body 10 and connected to the second outer electrode 22. Similarly, one end of the secondary coil 30b is extended to the outer surface of the base body 10 and connected to the third outer electrode 23, and the other end is extended to the outer surface of the base body 10 and connected to the fourth outer electrode 24.

The outer electrodes 20 are disposed on the outer surfaces of the base body 10 so as to extend across the first ferrite layer 17a, the second ferrite layer 16a, the glass layer 15, the third ferrite layer 16b, and the fourth ferrite layer 17b. In FIG. 1, the first outer electrode 21 and the third outer electrode 23 are disposed on the first side surface 13a of the base body 10, and the second outer electrode 22 and the fourth outer electrode 24 are disposed on the second side surface 13b of the base body 10. The first outer electrode 21, the second outer electrode 22, the third outer electrode 23, and the fourth outer electrode 24 may extend to the first main surface 12a and the second main surface 12b of the base body 10 to form a U-shape (C-shape) as illustrated in FIG. 1.

As illustrated in FIG. 1, a plurality of outer electrodes 20 may be present adjacent to each other on one outer surface of the base body 10. In the example illustrated in FIG. 1, the first outer electrode 21 and the third outer electrode 23 are present adjacent to each other on the first side surface 13a of the base body 10, and the second outer electrode 22 and the fourth outer electrode 24 are present adjacent to each other on the second side surface 13b of the base body 10.

The outer electrodes 20 each include, for example, a base electrode and a plating electrode disposed on the base electrode. The plating electrode may be composed of one layer or two or more layers. The outer electrodes 20 preferably contain at least Ag.

When the outer electrodes 20 each include a base electrode and a plating electrode, the base electrode is preferably a base electrode containing Ag or Cu, more preferably a base electrode containing Ag. The plating electrode is preferably either or both a Ni-plating electrode and a Sn-plating electrode, preferably both a Ni-plating electrode and a Sn-plating electrode. In particular, the outer electrodes 20 preferably each include a base electrode containing Ag, a Ni-plating electrode disposed thereon, and a Sn-plating electrode disposed thereon.

The coil component 1 is manufactured by, for example, the following method.

### <Step of Producing Glass Ceramic Material>

For example, K₂O, B₂O₃, SiO₂, and Al₂O₃ are weighed at a predetermined ratio and mixed in a platinum crucible or the like.

Next, the resulting mixture is melted by heating. The heating temperature is, for example, 1500° C. or higher and 1600° C. or lower (i.e., from 1500° C. to 1600° C.).

The resulting molten material is then rapidly cooled to produce a glass material.

The glass material preferably contains at least K, B, and Si, more preferably contains 0.5 wt % or more and 5 wt % or less (i.e., from 0.5 wt % to 5 wt %) of K in terms of K₂O, 10 wt % or more and 25 wt % or less (i.e., from 10 wt % to 25 wt %) of B in terms of B₂O₃, 70 wt % or more and 85 wt % or less (i.e., from 70 wt % to 85 wt %) of Si in terms of SiO₂, and 0 wt % or more and 5 wt % or less (i.e., from 0 wt % to 5 wt %) of Al in terms of Al₂O₃.

Next, the glass material is ground to prepare a glass powder. The median diameter D₅₀ of the glass powder is, for example, 1 μm or more and 3 μm or less (i.e., from 1 μm to 3 μm). For example, a quartz powder, an alumina powder, and a forsterite powder are prepared as fillers. The median diameter D₅₀ of the quartz powder, the alumina powder, and the forsterite powder is, for example, 0.5 μm or more and 2.0 μm or less (i.e., from 0.5 μm to 2.0 μm). The median diameter D₅₀ of the glass powder, the quartz powder, the alumina powder, and the forsterite powder refers to the particle size at 50% of the volume-based cumulative distribution.

The quartz powder, the alumina powder, and the forsterite powder are then added as fillers to the glass powder to produce a glass ceramic material (non-magnetic material).

The glass ceramic material preferably contains 70 wt % or more and 80 wt % or less (i.e., from 70 wt % to 80 wt %) of the glass powder, 2 wt % or more and 4 wt % or less (i.e., from 2 wt % to 4 wt %) of the alumina powder, 12 wt % or more and 14 wt % or less (i.e., from 12 wt % to 14 wt %) of the quartz powder, and 5 wt % or more and 15 wt % or less (i.e., from 5 wt % to 15 wt %) of the forsterite powder.

The glass ceramic material contains, relative to 100 wt % of the total weight, 9 wt % or more and 13 wt % or less (i.e., from 9 wt % to 13 wt %) of B in terms of B₂O₃, 2 wt % or more and 4 wt % or less (i.e., from 2 wt % to 4 wt %) of Al in terms of Al₂O₃, 75 wt % or more and 85 wt % or less (i.e., from 75 wt % to 85 wt %) of Si in terms of SiO₂, 0.5 wt % or more and 2 wt % or less (i.e., from 0.5 wt % to 2 wt %) of K in terms of K₂O, and 3 wt % or more and 10 wt % or less (i.e., from 3 wt % or more and 10 wt %) of Mg in terms of MgO.

### <Step of Producing Glass Ceramic Sheets>

The obtained glass ceramic material, an organic binder, such as a polyvinyl butyral resin, an organic solvent, such as ethanol or toluene, a plasticizer, and other materials are placed in a ball mill together with PSZ media and mixed to produce a glass ceramic slurry.

Next, the glass ceramic slurry is formed into a sheet with a predetermined thickness by using a doctor blade method or other methods, and the sheet is then punched into a predetermined shape to produce glass ceramic sheets. The thickness of the glass ceramic sheets is, for example, 20 μm or more and 30 μm or less (i.e., from 20 μm to 30 μm). The shape of the glass ceramic sheets is, for example, rectangular.

### <Step of Producing Low-Zn Ferrite Material>

For example, Fe₂O₃, ZnO, CuO, and NiO are weighed at a predetermined ratio. In this step, additives (sub-components), such as Mn₃O₄, Co₃O₄, SnO₂, Bi₂O₃, and SiO₂, may be added. In addition, incidental impurities may be contained.

Next, these weighed materials, pure water, a dispersant, and other materials are placed in a ball mill together with PSZ media, mixed, and then ground.

Subsequently, the resulting ground material is dried and then calcined. The calcination temperature is, for example, 700° C. or higher and 800° C. or lower (i.e., from 700° C. to 800° C.). The calcination time is, for example, 2 hours or more and 3 hours or less (i.e., from 2 hours to 3 hours).

The low-Zn ferrite material in a powder form is produced in this way.

The low-Zn ferrite material has a Zn/(Zn+Ni) of 0 or more and 0.73 or less (i.e., from 0 to 0.73). The low-Zn ferrite material preferably contains 40 mol % or more and 56 mol % or less (i.e., from 40 mol % to 56 mol %) of Fe in terms of Fe₂O₃, 1 mol % or more and 35 mol % or less (i.e., from 1 mol % to 35 mol %) of Zn in terms of ZnO, 6 mol % or more and 14 mol % or less (i.e., from 6 mol % to 14 mol %) of Cu in terms of CuO, and 8 mol % or more and 40 mol % or less (i.e., from 8 mol % to 40 mol %) of Ni in terms of NiO.

### <Step of Producing Low-Zn Ferrite Sheets>

The obtained low-Zn ferrite material in a powder form, an organic binder, such as a polyvinyl butyral resin, an organic solvent, such as ethanol or toluene, and other materials are placed in a ball mill together with PSZ media, mixed, and then ground to produce a low-Zn ferrite slurry.

Next, the low-Zn ferrite slurry is formed into a sheet with a predetermined thickness by using a doctor blade method or other methods, and the sheet is then punched into a predetermined shape to produce low-Zn ferrite sheets. The shape of the low-Zn ferrite sheets is, for example, rectangular.

### <Step of Producing Zn-Rich Ferrite Material>

For example, Fe₂O₃, ZnO, CuO, and NiO are weighed at a predetermined ratio. In this step, additives (sub-components), such as Mn₃O₄, Co₃O₄, SnO₂, Bi₂O₃, and SiO₂, may be added. In addition, incidental impurities may be contained.

Next, these weighed materials, pure water, a dispersant, and other materials are placed in a ball mill together with PSZ media, mixed, and then ground.

Subsequently, the resulting ground material is dried and then calcined. The calcination temperature is, for example, 700° C. or higher and 800° C. or lower (i.e., from 700° C. to 800° C.). The calcination time is, for example, 2 hours or more and 3 hours or less (i.e., from 2 hours to 3 hours).

The Zn-rich ferrite material in a powder form is produced accordingly.

The Zn-rich ferrite material has a Zn/(Zn+Ni) of more than 0.73 and 1.0 or less (i.e., from more than 0.73 to 1.0). The Zn-rich ferrite material preferably contains 40 mol % or more and 56 mol % or less (i.e., from 40 mol % to 56 mol %) of Fe in terms of Fe₂O₃, 36 mol % or more and 55 mol % or less (i.e., from 36 mol % to 55 mol %) of Zn in terms of ZnO, 6 mol % or more and 14 mol % or less (i.e., from 6 mol % to 14 mol %) of Cu in terms of CuO, and 0 mol % or more and 8 mol % or less (i.e., from 0 mol % to 8 mol %) of Ni in terms of NiO.

### <Step of Producing Zn-Rich Ferrite Sheets>

The obtained Zn-rich ferrite material in a powder form, an organic binder, such as a polyvinyl butyral resin, an organic solvent, such as ethanol or toluene, and other materials are placed in a ball mill together with PSZ media, mixed, and then ground to produce a Zn-rich ferrite slurry.

Next, the Zn-rich ferrite slurry is formed into a sheet with a predetermined thickness by using a doctor blade method or other methods, and the sheet is then punched into a predetermined shape to produce Zn-rich ferrite sheets. The shape of the Zn-rich ferrite sheets is, for example, rectangular.

### <Step of Forming Conductor Patterns>

A conductive paste, such as an Ag paste, is applied to predetermined glass ceramic sheets by using a screen printing method or other methods to form conductor patterns for coil conductors corresponding to the coil conductors 31 and 32 illustrated in FIG. 3, conductor patterns for via conductors corresponding to the via conductors 61 and 62 illustrated in FIG. 3, and conductor patterns for extended conductors corresponding to the extended conductors 71a, 71b, 72a, and 72b illustrated in FIG. 3. When forming the conductor patterns for via conductors, via holes are formed in advance by laser irradiation at predetermined locations on the glass ceramic sheets, and the via holes are then filled with the conductive paste.

### <Step of Producing Multilayer Body Block>

For example, the glass ceramic sheets each having a conductor pattern formed thereon are stacked in the stacking direction (the height direction T in this case) in the order illustrated FIG. 3, that is, in the order of the insulating layer 15a, the insulating layer 15b, the insulating layer 15c, and the insulating layer 15d as illustrated in FIG. 3. As illustrated in FIG. 3, a glass ceramic sheet having no conductor pattern formed thereon is stacked on one main surface of the resulting multilayer body in the stacking direction (the height direction in this case), that is, at the position of the insulating layer 15e illustrated in FIG. 3. Although not illustrated in FIG. 3, a glass ceramic sheet having no conductor pattern formed thereon may be stacked on the other main surface of the resulting multilayer body in the stacking direction (the height direction T in this case). The number of glass ceramic sheets having no conductor pattern formed thereon is not limited.

Next, a predetermined number of low-Zn ferrite sheets having no conductor pattern formed thereon are stacked on both main surfaces of the resulting multilayer body of the glass ceramic sheets in the stacking direction (the height direction T in this case). More specifically, the low-Zn ferrite sheets are stacked at the positions of the insulating layer 16aa and the insulating layer 16ab illustrated in FIG. 3, and the low-Zn ferrite sheets are stacked at the positions of the insulating layer 16ba and the insulating layer 16bb illustrated in FIG. 3.

Next, a predetermined number of Zn-rich ferrite sheets having no conductor pattern formed thereon are stacked on two resulting multilayer bodies of the low-Zn ferrite sheets in the stacking direction (the height direction in this case). More specifically, the Zn-rich ferrite sheets are stacked at the positions of the insulating layer 17aa, the insulating layer 17ab, and the insulating layer 17ac illustrated in FIG. 3, and the Zn-rich ferrite sheets are stacked at the positions of the insulating layer 17ba, the insulating layer 17bb, and the insulating layer 17bc illustrated in FIG. 3.

The resulting multilayer body composed of the glass ceramic sheets, the low-Zn ferrite sheets, and the Zn-rich ferrite sheets are then pressure-bonded together by using, for example, warm isostatic pressing (WIP) at a temperature of 80° C. and a pressure of 100 MPa or more and 160 MPa or less (i.e., from 100 MPa to 160 Mpa) to produce a multilayer body block.

### <Step of Producing Base Body and Coil>

First, the multilayer body block is cut into a predetermined size by using a dicer or the like to produce individual chips.

Next, the individual chips are fired. The firing temperature is, for example, 860° C. or higher and 920° C. or lower (i.e., from 860° C. to 920° C.). The firing time is, for example, 1 hour or more and 2 hours or less (i.e., from 1 hour to 2 hours).

By firing the individual chips, the glass ceramic sheets, the low-Zn ferrite sheets, and the Zn-rich ferrite sheets are each converted into an insulating layer. As a result, the multilayer portion composed of the glass ceramic sheets becomes a glass layer. Two multilayer portions composed of the low-Zn ferrite sheets become the second ferrite layer and the third ferrite layer. Two multilayer portions composed of the Zn-rich ferrite sheets become the first ferrite layer and the fourth ferrite layer. Furthermore, the conductor patterns for coil conductors, the conductor patterns for extended conductors, and the conductor patterns for via conductors respectively become the coil conductors, the extended conductors, and the via conductors. These conductors are electrically connected to each other to form a coil. In the present disclosure, the coil conductors, the extended conductors, and the via conductors are all included in the coil.

For example, the base body 10 including a multilayer body in which the first ferrite layer 17a, the second ferrite layer 16a, the glass layer 15, the third ferrite layer 16b, and the fourth ferrite layer 17b are stacked in this order, and the coil 30 including the primary coil 30a and the secondary coil 30b inside the glass layer 15 are produced in this way.

The corners and edges of the base body 10 may be rounded, for example, by placing the base body 10 in a rotary barrel machine together with media and subjecting the base body 10 to barrel polishing.

### <Step of Forming Outer Electrodes>

For example, a conductive paste, such as a paste containing Ag and glass frit, is applied to at least four locations, two on the first side surface 13a of the base body 10 and two on the second side surface 13b of the base body 10.

Next, each coating film thus obtained is baked at, for example, about 800° C. to form base electrodes on the outer surfaces of the base body 10.

Then, plating electrodes, such as a Ni-plating electrode and a Sn-plating electrode, are sequentially formed on the surface of each base electrode by electrolytic plating or other methods.

In this way, the outer electrodes 20 each including the base electrode and the plating electrode are formed on the outer surfaces of the base body 10.

The coil component 1 is manufactured as described above.

This description discloses the following contents.
<1> A coil component comprising a base body including a multilayer body in which a first ferrite layer, a second ferrite layer, a glass layer, a third ferrite layer, and a fourth ferrite layer are stacked in this order; a coil disposed inside the glass layer; and an outer electrode disposed on an outer surface of the base body and electrically connected to the coil. A ferrite material that constitutes the first ferrite layer, the second ferrite layer, the third ferrite layer, and the fourth ferrite layer contains X (X≥0) mol % of Zn in terms of ZnO and Y (Y≥0) mol % of Ni in terms of NiO, and X+Y>0, when amounts of Fe, Zn, Cu, and Ni are respectively expressed in terms of Fe₂O₃, ZnO, CuO, and NiO, and a total amount of Fe₂O₃, ZnO, CuO, and NiO is 100 mol %. A ferrite material that constitutes the second ferrite layer and the third ferrite layer has an X/(X+Y) of 0 or more and 0.73 or less (i.e., from 0 to 0.73), and a ferrite material that constitutes the first ferrite layer and the fourth ferrite layer has an X/(X+Y) of more than 0.73 and 1.0 or less (i.e., from more than 0.73 to 1.0).
<2> The coil component according to <1>, wherein the second ferrite layer and the third ferrite layer each have a thickness of 3.3 μm or more.
<3> The coil component according to <1> or <2>, wherein the second ferrite layer and the third ferrite layer each have a thickness of 110 μm or less.
<4> The coil component according to any one of <1> to <3>, wherein the glass layer contains at least one filler selected from the group consisting of quartz, alumina, and forsterite.
<5> The coil component according to any one of <1> to <4>, wherein the coil component is a common mode choke coil in which a primary coil and a secondary coil are disposed as the coil inside the glass layer.
<6> The coil component according to any one of <1> to <5>, wherein the first ferrite layer and the fourth ferrite layer each contain 40 mol % or more and 56 mol % or less (i.e., from 40 mol % to 56 mol %) of Fe in terms of Fe₂O₃, 36 mol % or more and 55 mol % or less (i.e., from 36 mol % to 55 mol %) of Zn in terms of ZnO, 6 mol % or more and 14 mol % or less (i.e., from 6 mol % to 14 mol %) of Cu in terms of CuO, and 0 mol % or more and 8 mol % or less (i.e., from 0 mol % to 8 mol %) of Ni in terms of NiO.
<7> The coil component according to any one of <1> to <6>, wherein the second ferrite layer and the third ferrite layer each contain 40 mol % or more and 56 mol % or less (i.e., from 40 mol % to 56 mol %) of Fe in terms of Fe₂O₃, 1 mol % or more and 35 mol % or less (i.e., from 1 mol % to 35 mol %) of Zn in terms of ZnO, 6 mol % or more and 14 mol % or less (i.e., from 6 mol % to 14 mol %) of Cu in terms of CuO, and 8 mol % or more and 40 mol % or less (i.e., from 8 mol % to 40 mol %) of Ni in terms of NiO.
<8> The coil component according to any one of <1> to <7>, wherein the first ferrite layer and the fourth ferrite layer have a magnetic permeability of 3 or less at 1 MHz.
<9> The coil component according to any one of <1> to <8>, wherein the second ferrite layer and the third ferrite layer have a magnetic permeability of 30 or more at 1 MHz.

### EXAMPLES

Examples, which more specifically disclose the coil component of the present disclosure, will be described below. The present disclosure is not limited only to these Examples.

### Example 1

A glass powder, an alumina powder, a quartz powder, and a forsterite powder were weighed at a predetermined ratio, and glass ceramic sheets were produced by using the methods described above in <Step of Producing Glass Ceramic Material> and <Step of Producing Glass Ceramic Sheet>.

A Fe₂O₃ powder, a NiO powder, a ZnO powder, and a CuO powder were weighed at a predetermined ratio, and low-Zn ferrite sheets were produced by using the methods described above in <Step of Producing Low-Zn Ferrite Material> and <Step of Producing Low-Zn Ferrite Sheet>. The Zn/(Zn+Ni) of the produced low-Zn ferrite material was 0 or more and 0.73 or less (i.e., from was 0 to 0.73).

A Fe₂O₃ powder, a NiO powder, a ZnO powder, and a CuO powder were weighed at a predetermined ratio, and Zn-rich ferrite sheets were produced by using the methods described above in <Step of Producing Zn-Rich Ferrite Material> and <Step of Producing Zn-Rich Ferrite Sheet>. The Zn/(Zn+Ni) of the produced Zn-rich ferrite material was more than 0.73 and 1.0 or less (i.e., from more than 0.73 to 1.0).

After printing conductor patterns on predetermined glass ceramic sheets by using the method described above in <Step of Forming Conductor Pattern>, a fired base body (chip) including a multilayer body was produced using the procedure described above in <Step of Producing Multilayer Body Block> and <Step of Producing Base Body and Coil> by stacking the glass ceramic sheets in the order illustrated in FIG. 3, stacking the low-Zn ferrite sheets on and under the stacked glass ceramic sheets, and stacking the Zn-rich ferrite sheets on and under the low-Zn ferrite sheets. In other words, a base body including a multilayer body in which the first ferrite layer, the second ferrite layer, the glass layer, the third ferrite layer, and the fourth ferrite layer were stacked in this order was produced.

In this Example, the thickness of the glass layer was 100 μm, the thickness of each of the second ferrite layer and the third ferrite layer was 5 μm, and the thickness of each of the first ferrite layer and the fourth ferrite layer was 185 μm.

The corners and edges of the fired base body were rounded by placing the fired base body in a rotary barrel machine together with media and subjecting the base body to barrel polishing.

The outer electrodes were formed on the fired base body using the procedure described above in <Step of Forming Outer Electrodes>.

The coil component was produced as a sample of Example 1 as described above.

### Example 2

A coil component was produced as a sample of Example 2 by the same method as in Example 1, except that the thickness of each of the second ferrite layer and the third ferrite layer was 10 μm, and the thickness of each of the first ferrite layer and the fourth ferrite layer was 180 μm.

### Example 3

A coil component was produced as a sample of Example 3 by the same method as in Example 1, except that the thickness of each of the second ferrite layer and the third ferrite layer was 20 μm, and the thickness of each of the first ferrite layer and the fourth ferrite layer was 170 μm.

### Example 4

A coil component was produced as a sample of Example 4 by the same method as in Example 1, except that the thickness of each of the second ferrite layer and the third ferrite layer was 30 μm, and the thickness of each of the first ferrite layer and the fourth ferrite layer was 160 μm.

### Example 5

A coil component was produced as a sample of Example 5 by the same method as in Example 1, except that the thickness of each of the second ferrite layer and the third ferrite layer was 50 μm, and the thickness of each of the first ferrite layer and the fourth ferrite layer was 140 μm.

### Example 6

A coil component was produced as a sample of Example 6 by the same method as in Example 1, except that the thickness of each of the second ferrite layer and the third ferrite layer was 70 μm, and the thickness of each of the first ferrite layer and the fourth ferrite layer was 120 μm.

### Example 7

A coil component was produced as a sample of Example 7 by the same method as in Example 1, except that the thickness of each of the second ferrite layer and the third ferrite layer was 90 μm, and the thickness of each of the first ferrite layer and the fourth ferrite layer was 100 μm.

### Example 8

A coil component was produced as a sample of Example 8 by the same method as in Example 1, except that the thickness of each of the second ferrite layer and the third ferrite layer was 110 μm, and the thickness of each of the first ferrite layer and the fourth ferrite layer was 80 μm.

### Comparative Example 1

A coil component was produced as a sample of Comparative Example 1 by the same method as in Example 1, except that the second ferrite layer and the third ferrite layer were not disposed, and the first ferrite layer and the fourth ferrite layer each having a thickness of 190 μm were stacked on and under the glass layer.

### Comparative Example 2

A coil component was produced as a sample of Comparative Example 2 by the same method as in Example 1, except that the first ferrite layer and the fourth ferrite layer were not disposed, and the second ferrite layer and the third ferrite layer each having a thickness of 190 μm were stacked on and under the glass layer.

### Reference Examples

Coil components were produced as samples of Reference Examples by the same method as in Example 1, except that ferrite layers composed of ferrite materials whose Zn/(Zn+Ni) values were varied by changing the ratio of Fe₂O₃ ZnO, CuO, and NiO were stacked on and under the glass layer.

The dimensions of the coil components serving as the samples of Examples, Comparative Examples, and Reference Examples are L=1.25 mm in the length direction, W=1.0 mm in the width direction, and T=0.50 mm in the height direction.

### [Evaluation 1]

Each of the samples of Reference Examples was stood upright so that the length direction L of the sample was oriented vertically, and each sample was embedded in resin. Each sample was then polished in the length direction L of the sample using a polishing machine to a depth at which an approximately central portion of the sample in the length direction L was exposed.

A region near the interface between the glass layer and the ferrite layers in the cross section (WT cross section) obtained by polishing was subjected to Si mapping by field emission-type wavelength dispersive X-ray analysis (FE-WDX). FE-WDX was performed using JXA-8530F available from JEOL Ltd. The analysis conditions are described below.
Acceleration voltage: 15.0 kV
Illumination current: 5×10⁻⁸ A
Number of pixels: 256×256
Pixel size: 0.4 (at a magnification of 1000×)
Dwell Time (acquisition time per pixel): 40 ms
Analysis Depth: 1 to 2 μm

As a result, in the sample of Reference Example with Zn/(Zn+Ni)=1.0, that is, the sample in which the ferrite layers were free of Ni and the Zn content was relatively high, the Si component in the glass layer eroded the ferrite layers, and the erosion length was 4 μm.

In the sample of Reference Example with Zn/(Zn+Ni)=0.73, that is, the sample in which the ferrite layers contained Ni and the Zn content was relatively low, the Si component in the glass layer eroded the ferrite layers, but the erosion length was as short as 3.3 μm. In other words, when Zn/(Zn+Ni) is 0.73 or less, it is possible to prevent or reduce the erosion of the ferrite layers caused by the Si component in the glass layer compared to the case with Zn/(Zn+Ni)=1.0.

The ferrite material used in Reference Example with Zn/(Zn+Ni)=0.73 contained 48.5 mol % of Fe in terms of Fe₂O₃, 31.75 mol % of Zn in terms of ZnO, 8.0 mol % of Cu in terms of CuO, and 11.8 mol % of Ni in terms of NiO.

### [Evaluation 2]

Each of the samples of Examples and Comparative Examples was stood upright so that the length direction L of the sample was oriented vertically, and each sample was embedded in resin. Each sample was then polished in the length direction L of the sample using a polishing machine to a depth at which an approximately central portion of the sample in the length direction L was exposed.

A region near the interface between the glass layer and the ferrite layers in the cross section (WT cross section) obtained by polishing was subjected to focused ion beam (FIB) processing and scanning ion microscope (SIM) observation at a magnification of 20 k to capture a SIM image. The obtained image was observed to determine whether erosion occurred at the interface between the glass layer and the ferrite layers, specifically whether the Si component in the glass layer eroded the ferrite layers. The results are shown in Table 1 below.

### [Evaluation 3]

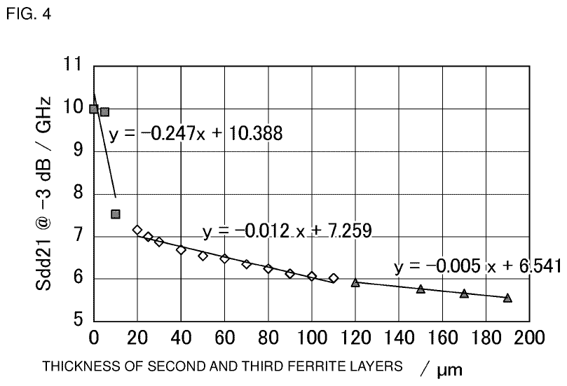

The samples of Examples and Comparative Examples were subjected to S-parameter simulation to calculate the cutoff frequency (the frequency at which the signal transmission characteristic Sdd21 is −3 dB). The results are shown in Table 1 below and FIG. 4.

FIG. 4 is a graph illustrating the cutoff frequencies of the samples in Examples and Comparative Examples, as obtained from the simulation.

FIG. 4 also shows the cutoff frequencies obtained from a model similar to that of Example 1 except that the second ferrite layer and the third ferrite layer each have a thickness of 25 μm and the first ferrite layer and the fourth ferrite layer each have a thickness of 165 μm, a model similar to that of Example 1 except that the second ferrite layer and the third ferrite layer each have a thickness of 40 μm and the first ferrite layer and the fourth ferrite layer each have a thickness of 150 μm, a model similar to that of Example 1 except that the second ferrite layer and the third ferrite layer each have a thickness of 60 μm and the first ferrite layer and the fourth ferrite layer each have a thickness of 130 μm, a model similar to that of Example 1 except that the second ferrite layer and the third ferrite layer each have a thickness of 80 μm and the first ferrite layer and the fourth ferrite layer each have a thickness of 110 μm, a model similar to that of Example 1 except that the second ferrite layer and the third ferrite layer each have a thickness of 100 μm and the first ferrite layer and the fourth ferrite layer each have a thickness of 90 μm, a model similar to that of Example 1 except that the second ferrite layer and the third ferrite layer each have a thickness of 120 μm and the first ferrite layer and the fourth ferrite layer each have a thickness of 70 μm, a model similar to that of Example 1 except that the second ferrite layer and the third ferrite layer each have a thickness of 150 μm and the first ferrite layer and the fourth ferrite layer each have a thickness of 40 μm, and a model similar to that of Example 1 except that the second ferrite layer and the third ferrite layer each have a thickness of 170 μm and the first ferrite layer and the fourth ferrite layer each have a thickness of 20 μm.

The calculated cutoff frequencies were evaluated on the basis of the following criteria. The results are shown in Table 1 below.
A (good): The cutoff frequency is 6 GHz or higher.
B (poor): The cutoff frequency is lower than 6 GHz.

TABLE 1

| | Comparative | Examples | | | | | | | | Comparative |
|---|---|---|---|---|---|---|---|---|---|---|
| | Example 1 | 1 | 2 | 3 | 4 | 5 | 6 | 7 | 8 | Example 2 |
| Thickness | 0 | 5 | 10 | 20 | 30 | 50 | 70 | 90 | 110 | 190 |
| (μm) of | | | | | | | | | | |
| second ferrite | | | | | | | | | | |
| layer | | | | | | | | | | |
| Presence or | present | absent | absent | absent | absent | absent | absent | absent | absent | absent |
| absence of | | | | | | | | | | |
| erosion | | | | | | | | | | |
| Cutoff | 10.0 | 9.9 | 7.5 | 7.2 | 6.9 | 6.6 | 6.4 | 6.1 | 6.0 | 5.6 |
| frequency | A | A | A | A | A | A | A | A | A | B |
| (GHz) | | | | | | | | | | |

Referring to Table 1, no erosion of the second ferrite layer and the third ferrite layer caused by the Si component in the glass layer was observed in the samples of Examples and Comparative Example 2 in which the glass layer was sandwiched between the second ferrite layer and the third ferrite layer composed of the low-Zn ferrite material.

Table 1 and FIG. 4 indicate that, when the second ferrite layer and the third ferrite layer each have a thickness of 110 μm or less, the cutoff frequency is 6 GHz or higher, and good high-frequency characteristics are obtained (a higher Sdd21 is better).

The cutoff frequency of the sample in Comparative Example 1 was 10.0 GHZ, because the upper limit of the cutoff frequency in the simulation is 10.0 GHz. The actual cutoff frequency of the sample in Comparative Example 1 is considered to exceed 10.0 GHz.

What is claimed is:

1. A coil component comprising:
a base body including a multilayer body in which a first ferrite layer, a second ferrite layer, a glass layer, a third ferrite layer, and a fourth ferrite layer are stacked in this order;
a coil inside the glass layer; and
an outer electrode on an outer surface of the base body and electrically connected to the coil,
wherein
a ferrite material that configures the first ferrite layer, the second ferrite layer, the third ferrite layer, and the fourth ferrite layer includes X (X≥0) mol % of Zn in terms of ZnO and Y (Y≥0) mol % of Ni in terms of NiO, and X+Y>0, when amounts of Fe, Zn, Cu, and Ni are respectively expressed in terms of Fe₂O₃, ZnO, CuO, and NiO, and a total amount of Fe₂O₃, ZnO, CuO, and NiO is 100 mol %,
a ferrite material that configures the second ferrite layer and the third ferrite layer has an X/(X+Y) of from 0 to 0.73, and
a ferrite material that configures the first ferrite layer and the fourth ferrite layer has an X/(X+Y) of more than 0.73 to 1.0.

2. The coil component according to claim 1, wherein
the second ferrite layer and the third ferrite layer each have a thickness of 3.3 μm or more.

3. The coil component according to claim 1, wherein
the second ferrite layer and the third ferrite layer each have a thickness of 110 μm or less.

4. The coil component according to claim 1, wherein
the glass layer includes at least one filler selected from the group consisting of quartz, alumina, and forsterite.

5. The coil component according to claim 1, wherein
the coil component is a common mode choke coil in which a primary coil and a secondary coil are configured as the coil inside the glass layer.

6. The coil component according to claim 1, wherein
the first ferrite layer and the fourth ferrite layer each includes from 40 mol % to 56 mol % of Fe in terms of Fe₂O₃, from 36 mol % to 55 mol % of Zn in terms of ZnO, from 6 mol % to 14 mol % of Cu in terms of CuO, and from 0 mol % to 8 mol % of Ni in terms of NiO.

7. The coil component according to claim 1, wherein
the second ferrite layer and the third ferrite layer each includes from 40 mol % to 56 mol % of Fe in terms of Fe₂O₃, from 1 mol % to 35 mol % of Zn in terms of ZnO, from 6 mol % to 14 mol % of Cu in terms of CuO, and from 8 mol % to 40 mol % of Ni in terms of NiO.

8. The coil component according to claim 1, wherein
the first ferrite layer and the fourth ferrite layer have a magnetic permeability of 3 or less at 1 MHz.

9. The coil component according to claim 1, wherein
the second ferrite layer and the third ferrite layer have a magnetic permeability of 30 or more at 1 MHz.

10. The coil component according to claim 2, wherein
the second ferrite layer and the third ferrite layer each have a thickness of 110 μm or less.

11. The coil component according to claim 2, wherein
the glass layer includes at least one filler selected from the group consisting of quartz, alumina, and forsterite.

12. The coil component according to claim 3, wherein
the glass layer includes at least one filler selected from the group consisting of quartz, alumina, and forsterite.

13. The coil component according to claim 2, wherein
the coil component is a common mode choke coil in which a primary coil and a secondary coil are configured as the coil inside the glass layer.

14. The coil component according to claim 3, wherein
the coil component is a common mode choke coil in which a primary coil and a secondary coil are configured as the coil inside the glass layer.

15. The coil component according to claim 2, wherein
the first ferrite layer and the fourth ferrite layer each includes from 40 mol % to 56 mol % of Fe in terms of Fe₂O₃, from 36 mol % to 55 mol % of Zn in terms of ZnO, from 6 mol % to 14 mol % of Cu in terms of CuO, and from 0 mol % to 8 mol % of Ni in terms of NiO.

16. The coil component according to claim 3, wherein
the first ferrite layer and the fourth ferrite layer each includes from 40 mol % to 56 mol % of Fe in terms of Fe₂O₃, from 36 mol % to 55 mol % of Zn in terms of ZnO, from 6 mol % to 14 mol % of Cu in terms of CuO, and from 0 mol % to 8 mol % of Ni in terms of NiO.

17. The coil component according to claim 2, wherein
the second ferrite layer and the third ferrite layer each includes from 40 mol % to 56 mol % of Fe in terms of Fe₂O₃, from 1 mol % to 35 mol % of Zn in terms of ZnO, from 6 mol % to 14 mol % of Cu in terms of CuO, and from 8 mol % to 40 mol % of Ni in terms of NiO.

18. The coil component according to claim 3, wherein
the second ferrite layer and the third ferrite layer each includes from 40 mol % to 56 mol % of Fe in terms of Fe₂O₃, from 1 mol % to 35 mol % of Zn in terms of ZnO, from 6 mol % to 14 mol % of Cu in terms of CuO, and from 8 mol % to 40 mol % of Ni in terms of NiO.

19. The coil component according to claim 2, wherein
the first ferrite layer and the fourth ferrite layer have a magnetic permeability of 3 or less at 1 MHz.

20. The coil component according to claim 2, wherein
the second ferrite layer and the third ferrite layer have a magnetic permeability of 30 or more at 1 MHz.
